(19) United States
(12) Patent Application Publication
(10) Pub. No.: US 2008/0188363 A1
(43) Pub. Date: Aug. 7, 2008

(54) Highly Flexible Machine Tool Comprising Several Workpiece Supports

(75) Inventors: Frank Baumbusch, Eberbach (DE); Walter Bauer, Simozheim (DE)

Correspondence Address: COHEN, PONTANI, LIEBERMAN & PAVANE LLP, 551 FIFTH AVENUE, SUITE 1210, NEW YORK, NY, 10176, US

(73) Assignee: Witzig & Frank GmbH, Offenburg (DE)

(21) Appl. No.: 11/665,553

(22) PCT Filed: Oct. 7, 2005
(86) PCT No.: PCT/EP05/10808

§ 371 Date: Mar. 17, 2008

(30) Foreign Application Priority Data
Oct. 15, 2004 (DE) 10 2004 050 199.8

(51) Int. Cl. B23Q 41/02; B23Q 41/00

(52) U.S. Cl. 483/15; 29/563

(57) ABSTRACT

A machine tool (1) has a work chamber (3), in which two workpiece supports (7, 8) can move independently of one another. A plurality of tool bits (44, 45) are also disposed in the work chamber. Movement devices which define movement regions are assigned to the workpiece supports (7, 8). These movement devices overlap one another in a region in which a machining unit (35) can be disposed. With such a machine tool, very high flexibility in terms of the workpieces to be produced as well as high productivity are achieved. The machine tool (1) thus makes it possible to achieve high degrees of automation, even with small-scale mass production.

The invention relates to a machine tool.

For flexible machining of workpieces, various machine concepts have been developed that permit metal-cutting machining of the workpiece from a plurality of different directions in space. Machines for four-sided or five-sided machining of workpieces are known, in which except for the chucking face itself, all the other faces can be machined in metal-cutting fashion. In this way, workpieces of complex shape can be produced for the automotive industry, for instance.

One such machine tool is known from German Patent DE 43 01 393 C2. This machine tool is embodied as a revolving machine. It has a work chamber, in which a cross-shaped workpiece support is disposed. Planet tables for receiving the workpiece are disposed on the side faces of the arms. The workpiece support is rotated in 90° increments. In the process, the workpieces retained on the arms of the workpiece support pass successively through all the machining stations. Each machining station includes at least one machining unit with at least one machining spindle, on which milling or drilling tool bits, for instance, can be fastened.

With such a machine, high productivity can be attained. It is well suited to relatively large-scale mass production.

From German Patent Disclosure DE 39 41 480 A1, a further machine tool, operating on the revolving principle is known. The machine tool has a cagelike tool bit-receiving chamber, in which a turntable is suspended. This is polygonally edged. It has planet tables on its outside. Machining units are arranged around the machine frame, and their angular orientation and angular embodiment are selected specifically for a particular workpiece.

With this machine tool, extremely high productivities in large-scale mass production can be achieved.

From German Patent Disclosure DE 36 24 284 A1, a machining tool is known which includes a pivotably supported workpiece chucking location and an associated machining unit. Via the relative motion between the machine spindle, the machining unit, and the workpiece, the desired machining operations on a workpiece can be performed. This machine is suitable for individual manufacture or extremely small-scale mass production.

From German Patent Disclosure DE 43 16 166 B4, a vertical power lathe is also known, which has a first spindle case, supported on a carriage and movable horizontally and vertically, and a second spindle case, disposed as stationary on a machine frame. A movably disposed workpiece support is associated with the stationary spindle case. A workpiece support disposed in stationary fashion is associated with the movable spindle case. The guide path of the movable spindle case extends past the stationary spindle case, so that workpieces can be transferred in a position where they are opposite one another.

From German Patent Disclosure DE 101 17984 A1, a power lathe is also known, with two spindle cases supported on parallel paths of horizontally adjustable carriages. A guide device for two workpiece supports movable independently of one another extends transversely across the two guide paths of the spindle cases. With this power lathe, relatively flexible workpiece machining is possible.

Still another flexible power lathe is known from DE 199 04 859 A1. It has two chucks, movable in three axes and diametrically opposite one another, for one workpiece. The spindle cases are moreover supported pivotably, so that they can pivot the pivot shaft out of a horizontal position to a vertical position, in which the machining takes place by means of tool bits that are retained in a workpiece support located below the spindles. For eccentric machining of workpieces, the spindles can be locked in a defined rotary position by motion-stopping devices.

All the machining operations to be done on the workpiece must be accomplished with the tool bits provided on the tool holder.

With this as the point of departure, it is the object of the invention to create a machine tool which is suitable for both relatively small-scale and relatively large-scale mass production and is highly flexible in each case, or in other words can be set up easily and simply for different workpieces and machining operations, and which in each case provides good productivity.

This object is attained with the machine tool as defined by claim 1:

The machine tool of the invention has a work chamber, in which at least two workpiece supports are disposed. Both workpiece supports are connected to movement devices, so that they can be moved at least two-dimensionally in the work chamber. The movement devices define movement regions that are located in the work chamber. The movement regions of the two workpiece supports can be defined independently of one another. This means that one workpiece support can take a different path than the other workpiece support. Nevertheless, the two paths can be defined such that each workpiece support approaches either all the machining units or only selected machining units in order to have machining operations performed there on the workpiece. With this concept of the mutually independent motion of a plurality of tool bits in a common work chamber over optionally different paths, a high degree of flexibility is attained. If a changeover is to be made from a workpiece that requires many machining operations, such as grinding, honing, press-fitting in of bushes, and so forth, to a workpiece that requires only a few machining operations or requires only a few machining units to be approached, then the path of the applicable workpiece support can be programmed accordingly, resulting in only a short distance through the machine and a short machining time. In a revolving machine, the workpiece must in any case pass through the entire circular distance.

With the machine tool of the invention, it is also possible in principle to produce different workpieces in parallel. In particular, different courses through the machine can be selected and as a result different machining sequences, different machining operations, and different durations of machining can be attained.

The movement regions of the workpiece supports can overlap one another either completely or partially. As a rule, a partial overlap suffices; the overlapping region preferably includes all the machining positions, but it does define at least one, which is defined by a position that can be assumed by a machining unit.

The movement devices may be formed by spindle lifting drive mechanisms or rack drive mechanisms, or preferably at least in part by linear motors. In particular, linear motor drives are preferred for relatively long adjustment distances, while short adjustment distances can be attained by means of motor gear assemblies. For instance, the linear motor defines a direction of motion in which a plurality of machining devices can be achieved. The motor gear movement devices, conversely, can be used to achieve only short approach motions or the like.

The motions of the workpiece supports are preferably two-dimensional or in other words biaxial. Preferably, both directions of motion are located in a common plane, preferably a horizontal plane. The directions of motion of a plurality of machining units are preferably disposed in one common plane. However, the movement devices may as needed also be provided with a third direction of motion (or axis), so that they can execute genuine 3D motions (three-dimensional motions). While the movement regions in the first case are defined by surfaces, in the second case they are defined by the volumes that in principle can be traversed.

In addition to the linear directions of motion, the workpiece receptacles can also be pivoted about at least one but preferably about two axes. Thus genuine pentaxial, five-sided machining of each workpiece is possible.

The workpiece supports may be provided with an automatic clamping device. It is thus possible, especially as a result of the overlap of the movement regions, for workpieces in the work chamber to be transferred from one workpiece support to another workpiece support. By this provision, genuine six-sided machining can be achieved, without requiring manual rechucking of the workpiece. For rechucking, the workpiece need not be moved out of the work chamber, either.

This provision accordingly offers extremely high flexibility. The production-related restrictions with regard to the machine tool that have to be taken into account in designing workpieces are reduced to a minimum.

The at least one machining unit is assigned a positioning unit, which permits a motion of the machining unit in at least one direction, but preferably in two or more directions. The approach motion can be effected by means of a motion of the workpiece, or a motion of the tool bit. It is also possible to put the tool bits of two or more machining units into engagement with the workpiece simultaneously. Then the number of possible positioning devices of the simultaneously operative machining units may differ. For instance, it is possible for one machining unit, located below the workpiece, to be able to execute only an axial approach motion, while a machining unit located above the tool bit is movable in three positioning directions. If milling is to be done with the lower tool bit, the workpiece is moved accordingly. The upper tool bit then follows this motion, and superimposed on that motion is the actual approach motion,

The positioning units for the machining units can also each contain at least one linear motor. The linear motor is preferably associated with the longest adjustment distance that occurs. As a rule, this is a distance oriented transversely to the pivot axis of the tool bit.

The machining units may be provided with turret heads, so that they can keep a plurality of tool spindles, with a plurality of tool bits, in readiness. In addition, at least as needed, tool bit magazines may be provided, which cooperate with corresponding tool bit changing devices in order to replace the tool bits of individual work spindles.

The machining units are as a rule located at different places in the movement region, so that they can be approached in succession. The movement region spans at least two machining units, so that subsequent machining operations can also be performed. The machining units are for instance work spindles with tool bits for metal-cutting machining, such as milling, drilling, thread cutting, grinding, polishing, lapping, and honing. Machining units may furthermore be provided for eroding or for performing assembly operations. A typical assembly operation is press-fitting in of bushes, inserting screws, or the like.

Further details of advantageous embodiments of the invention are the subject of the drawings, description or claims.

Exemplary embodiments of the invention are shown in the drawings. Shown are:

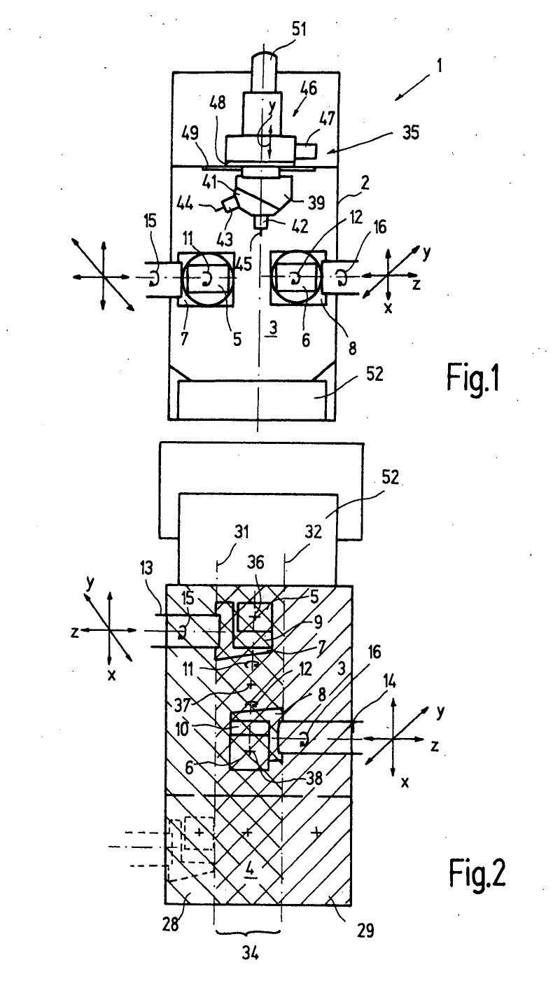

FIG. 1, a machine tool in a schematic front view;

FIG. 2, the machine tool of FIG. 1 in a schematic top view, with shading showing the existing movement regions;

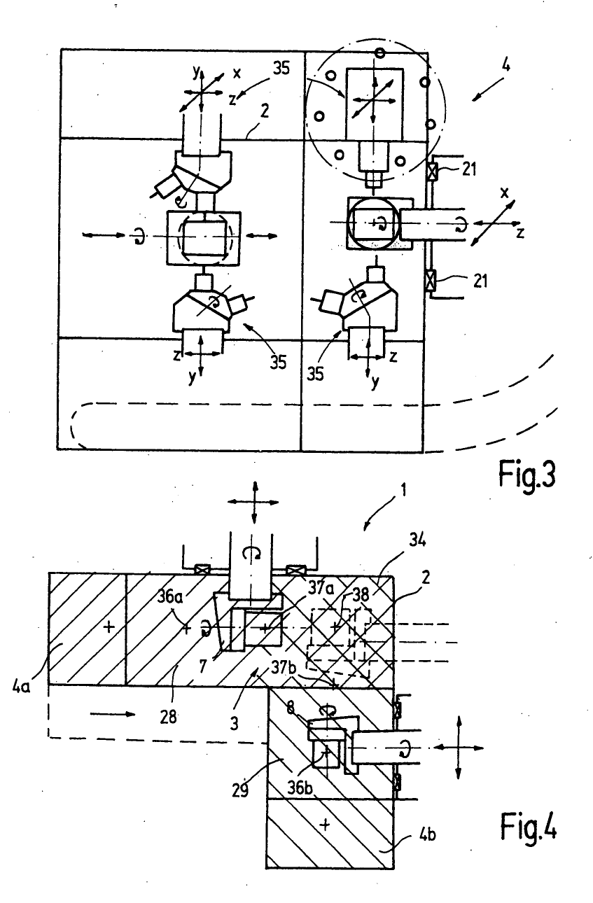

FIG. 3, a modified embodiment of a machine tool in a front view;

FIG. 4, the machine tool of FIG. 3 in a schematic top view;

FIG. 5, a further-modified embodiment of the machine tool of the invention in a front view;

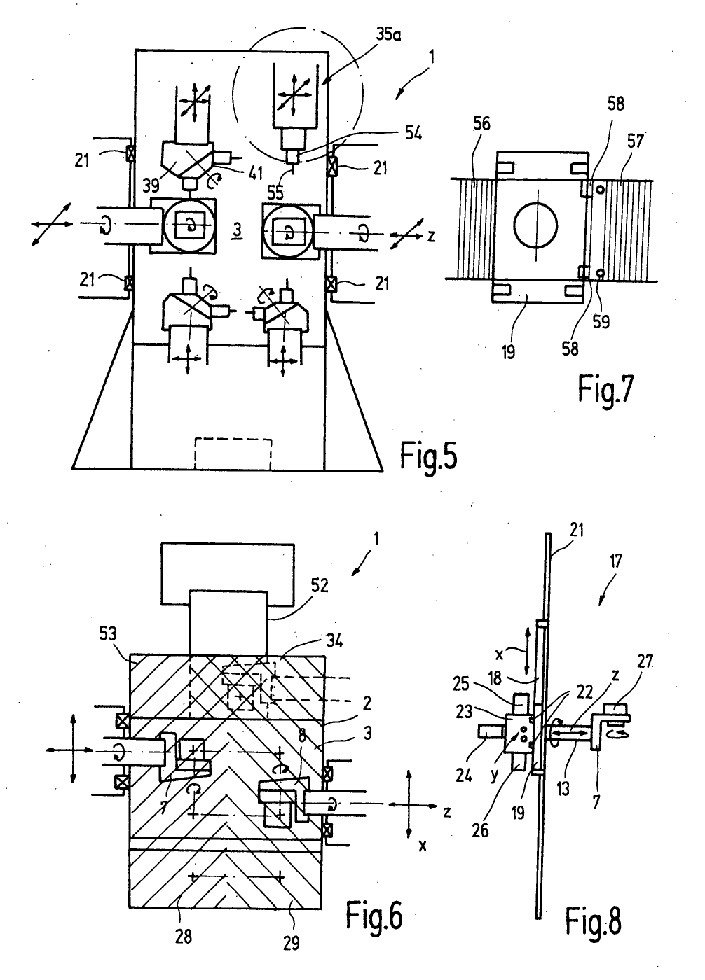

FIG. 6, the machine tool of FIG. 5 in a schematic top view;

FIG. 7, the machine tool of FIG. 5 in a schematic, fragmentary back view; and

FIG. 8, a movement device of one of the machine tools of FIGS. 1 through 6, shown schematically.

In FIG. 1, a machine tool 1 is shown, which has a preferably cagelike machine frame 2 that surrounds a work chamber 3. The work chamber is closed off from the outside, preferably to such an extent that chips, dust and cooling lubricant cannot escape to the outside in significant amounts. As FIG. 2 shows, an assembly chamber 4 borders on the work chamber 3 and is separated from the work chamber 3 by spatial removal or by partitioning provisions, to such an extent that workpieces can be introduced into and taken out of the assembly chamber 4 while workpieces 5, 6 are being machined in the work chamber 3.

The workpieces 5, 6 are individually assigned workpiece supports 7, 8. These workpiece supports are shown in various positions in FIGS. 1 and 2. Preferably, each workpiece support 7, 8 has one tool chucking place, embodied as a planet table 9, 10, which is provided with automatic chucking means, not shown in further detail, such as pressure-fluid-actuated clamping tongs. The planet table 9, 10 permits a rotation and positioning about an axis oriented perpendicular to the chucking face, as indicated in FIGS. 1 and 2 by respective arrows 11, 12, as well as a fixation of the workpiece in predetermined pivoted positions. The workpiece support 7, 8 is also carried by a cantilevered part 13, 14 that is rotatably supported about its longitudinal axis. The corresponding direction of rotation is indicated in FIGS. 1 and 2 by arrows 15, 16. The workpiece in turn can be fixed in definable pivoted positions. The cantilevered parts 13, 14 are furthermore movable in two—or as shown, three—linear directions of motion X, Y, Z. This is achieved with a movement device 17, which is shown in FIG. 8 as an example for the workpiece support 7 and the cantilevered part 13. A movement device of the same kind can be provided for the workpiece support 8.

The movement device 17, for adjustment in the X direction, has a linear motor 18, the movable portion of which is connected to a carriage 19. The carriage 19 is guided on rails 21 that extend in the X direction, for instance horizontally. The straight rails 21 preferably have a length that is so great that the cantilevered part 13, with the workpiece support 7, can move not only through the entire work chamber 3 but also into the assembly chamber 4. In FIG. 8, the movement device is shown for three movement axes. To enable an adjustment in the vertical Y direction, the carriage 19 in turn has rails 22, on which a vertically adjustable (positionable) carriage 23 is shown. This carriage carries the cantilevered part 13, supported rotatably. For rotating and positioning the cantilevered part 13, a motor 24 is provided. A motor 25 brings about a linear positioning of the cantilevered part 13 in its longitudinal direction, which forms the Z direction. A further motor 26 serves the purpose of positioning in the Y direction. Finally, a motor 27 is seated on the workpiece support 7 and serves to rotate and position the planet table.

Such movement devices may be provided for each workpiece support 7, 8. The movement device 17 may also be modified such that the motor 26 and the associated rails 22 are omitted, so that only a biaxial linear adjustment is possible.

The movement devices 17 define independent movement regions 28, 29 for the respective workpiece supports 7, 8; these movement regions are shown shaded in FIG. 2. The movement regions 28, 29 are each shown bounded by a dot-dashed line 31, 32. In a middle region 24, which in FIG. 2 has cross-hatched shading, the movement regions 28, 29 overlap. The region 34 can thus be traversed by both workpiece supports 7, 8 and thus both workpieces 5, 6. On both sides of the region 34, there are zones that belong to only the movement region 28 and only to the movement region 29, respectively, and that can thus be traversed by only the one workpiece support 7 or only the other workpiece support 8.

Preferably above the middle region 34 on the machine frame 2, at least one and preferably more machining units are provided, of which one machining unit 35 is shown as an example in FIG. 1. They are disposed above on the machine frame 2 in one row, and their center axis in FIG. 2 is marked in each case by a respective cross 36, 37, 38. The machining units are embodied largely identically to one another. For instance, they have a turret head 39, whose rotatable turret part 41 has a plurality of work spindles 43, 44. The turret part 41 is provided with eight work spindles, for instance. One tool 44, 45 can be secured to each of them.

A positioning unit 46 is associated with the turret 39 in order to move the turret 39 in at least one direction, such as the Y direction. To that end, a suitable control motor 47 can be used. In addition, a linear motor 48 or some other kind of linear drive mechanism may be provided, in order to move the turret 39 along rails 49, oriented for instance in the Z direction. The drive of the work spindles 42, 43 of the turret 39 is effected via a drive motor 41. Instead of the control motor 47, a linear drive mechanism in the form of a linear motor may be provided.

The machine tool 1 described thus far functions as follows:

The workpiece supports 7, 8 are moved into the assembly chamber 4 in alternation. In FIG. 2, the workpiece support 7 is shown in dashed lines in the assembly position. Here, workpieces can be changed by manual or machine access. Based on this assembly position, the chucked workpiece 5 then traverses a course that leads through the region 34. This course leads to at least one machining station 35, or to a plurality of machining units. For instance, all the machining units marked by the crosses 36, 37, 38 (FIG. 2) can be traversed. The workpiece supports 7, 8 may, as shown in FIG. 2, successively traverse the same machining course, but before that and afterward can take separate courses.

In the individual machining stations, which are formed by the associated machining unit 35, the workpiece 5 and the workpiece 6 can each be positioned arbitrarily. It can be displaced linearly in the X, Y, and Z direction. It can be pivoted, by pivoting the workpiece support 7, 8 about the longitudinal axis of the respective cantilevered part 13, 14 as indicated by the respective arrows 15 and 16. Each planet table 9, 10 can also be rotated. Thus both purely five-sided machining with the workpiece 5, 6 in repose and machining with the workpiece 5, 6 in motion, as in the case of rotary milling are possible.

Chips that occur in the work chamber 3 can be removed by a chip conveyor 52, which is indicated symbolically in FIGS. 1 and 2.

FIGS. 3 and 4 show a modified embodiment of the machine tool 1. While in the machine tool 1, both movement regions 28, 29 are parallel to one another and overlap one another in a striplike region 34, in the machine tool 1 of FIG. 4 the movement regions 28, 29 are at a right angle to one another. Still other angular orientations may also be employed. The machine has a common machine frame 2, which is embodied on the order of an angle. The assembly chambers 4a, 4b are embodied on the ends of its legs. Between the two assembly chambers 4a, 4b is an angular work chamber 3, which contains both the movement regions 28, 29 and the overlapping region 34. The positions of the machining units 35 are again marked in FIG. 4 by crosses 36a, 37a, 38, 36b, 37b. The description given in conjunction with FIGS. 1 and 2 applies to these machining units and their positioning unit. It can additionally be seen from FIG. 3 that the machine frame 2 not only has machining units 35 suspended at the top but also additionally has machining units 35 below the machining plane defined by the workpieces 5, 6. These lower machining units 35 are in turn embodied as crown turrets. They are adjustable in at least one direction, such as the vertical Y direction. In addition, they may be adjustable in a horizontal direction (Z direction and/or X direction). Otherwise, the above description applies.

The special feature of this machine tool 1 is that both workpiece supports 7, 8 can work completely independently of one another, because the machining units at the crosses 36a, 37a can be used individually by the workpiece support 7, and the machining units at the crosses 36b, 37b can be used individually by the workpiece support 8. The machining unit at the cross 38 can be used jointly. Moreover, this position can be used as a transfer position. For instance, the workpiece support 8 is then located in the position shown in dashed lines in FIG. 4. This position can be approached by the workpiece support 7. If that workpiece support is initially empty, it can take on the workpiece held by the workpiece support and grasp and chuck it, whereupon the workpiece can be released by the workpiece support 8. This rechucking operation that takes place in the work chamber 3 makes genuine six-sided machining possible.

Thus the machine tool 1 of FIGS. 3 and 4 can be used both as a six-sided machining tool for a workpiece, which is for instance inserted into the machine tool in the assembly chamber 4b and withdrawn from the machine tool 1 in the assembly chamber 4a, and as a machine tool that at the assembly chambers 4a and 4b each receives and gives up workpieces that have been individually machined. Very high flexibility is possible, and high productivity is nevertheless achieved.

FIGS. 5 and 6 illustrate a further embodiment of the machine tool 1. For example, it has eight machining units, four of them located above on the machine frame 2 and two or four others of which are located below on the machine frame 2. The positioning devices and the movement devices are embodied as described above. As in all the machines described above, the turrets 39 serve to put tool bits, which may be different, that are held on different work spindles into work positions so that successively, different work operations can be performed on the particular workpiece. The movement regions 28, 29 may be adjacent one another approximately centrally in the work chamber 3, and may overlap there to a greater or lesser extent or even not at all. In the latter case, the machining units shown on the left in FIGS. 5 and 6 are associated individually with the workpiece support 7. The machining units shown on the right in FIGS. 5 and 6 are likewise individually associated with the workpiece support 8.

A section 53 in which the movement regions 28, 29 overlap can be attached to the work chamber 3. This overlap can be achieved for instance by suitable programming of the movement device 17 or its controller. Thus once again an overlapping region 34 can be attained which can for instance be used as a transfer region for transferring workpieces from the workpiece support 7 to the workpiece support 8. As needed, one or more machining units may also be disposed here. Assembly units, for instance for press-fitting bushes in or for performing other assembly operations, may also be provided.

The machining units are preferably provided with turrets 39. However, it is also possible to provide machining units 35a that have only a single work spindle 54 with a single tool bit 55. This is shown as an example in FIG. 5, and also in FIG. 3. A disklike tool bit change magazine 54a can be provided for keeping further tool bits in readiness. This is always appropriate whenever all the tool bits for machining a certain range of parts are to be disposed on the machine tool, to make automatic machine conversion possible. This kind of tool bit change magazine is also appropriate whenever machining is to be done of workpieces that are difficult to machine, for which purpose a plurality of identical tool bits (sister tool bits) may be provided that enable an automatic change of tool bits at the end of their service life.

Instead of the machining units shown, still other machining units may also be employed.

Particularly for the machine concept of FIGS. 5 and 6, the work chamber 3 is largely closed off from the outside. To assure accessibility nevertheless, the free space existing between the rails 21 may be utilized. The window located here in the machine frame 2 and between the rails 21 is spanned by the carriage 19, which finally guides the cantilevered part 13. The carriage 19 is adjoined, as FIG. 7 shows, on both sides by bellowslike blinds 56, 57. These blinds follow the motions of the carriage and in the process cover the window left open between the rails 21. The blinds 56, 57 are joined to the carriage 19 by a coupling means 58. The coupling means is detachable. Thus the window can for instance be opened by first moving the carriage to its extreme position on the right or left, in which one of the two sets of blinds, for instance the blinds 57, has its shortest length, or in other words is compressed all the way. In this position, the blinds can be locked, for instance with socket pins in suitable holes 59 provided on the machine frame 2, or locked by other coupling means, while conversely the coupling with the carriage 19 is released. If the carriage 19 then moves into its other extreme position, it uncovers the window without the window being covered by the blinds 57. At the same time, the blinds 56 are pushed together.

Either both blinds 56, 57, or only one of the two sets, may be detachably connected to the carriage 19 and may be firmly lockable to the machine frame 2 by suitable means, such as socket pins.

A machine tool 1 has a work chamber 3, in which two workpiece supports 7, 8 can move independently of one another. A plurality of tool bits 44, 45 are also disposed in the work chamber. Movement devices 17 which define movement regions 28, 29 are assigned to the workpiece supports 7, 8. These movement devices overlap one another in a region 34 in which a machining unit 35 can be disposed. With such a machine tool, very high flexibility in terms of the workpieces to be produced as well as high productivity are achieved. The machine tool 1 thus makes it possible to achieve high degrees of automation, even with small-scale mass production.

### LIST OF REFERENCE NUMERALS

1 Machine tool
2 Machine frame
3 Work chamber
4Machining chamber
5, 6 Workpieces
7, 8 Workpiece supports
9, 10 Planet tables
11, 12 Arrows
13, 14 Cantilevered parts
15, 16 Arrows
17 Movement device
18 Linear motor
19 Carriage
21, 22 Rails
23 Carriage
24 Motor, pivoting motor
25 Z motor
26 Y motor
27 Planet motor
28, 29 Movement regions
31, 33 Line
34 Region
35 Machining unit
36, 37, 38 Cross
39 Turret
41 Turret part
42, 43 Work spindle
44, 45 Tool bit
46 Positioning unit
47 Control motor
48 Linear motor
49 Rails
51 Drive motor
52 Chip conveyor
53 Section
54 Work spindle
54a Tool bit change magazine
55 Tool bit
56, 57 Blinds
58 Coupling means
59 Holes

1. A machine tool (1) for machining workpieces,
having a work chamber (3);
having a plurality of machining units (35), which carry driven tool bits (44, 45) that are disposed in the work chamber (3), the machining units forming machining stations, which can be approached by the workpieces in a programmable machining sequence;
having at least two workpiece supports (7, 8), which are disposed in the work chamber (3) and to each of which individual movement devices (17) are assigned, so that each workpiece support (7, 8) is movable within its own movement region (28, 29), located in the work chamber, and the workpiece supports (7, 8), for machining the workpieces to suit the machining sequence, are movable into predetermined positions in order to position the workpieces for machining.

2. The machine tool as defined by claim 1, characterized in that the movement regions (28, 29) overlap one another at least in some regions.

3. The machine tool as defined by claim 1, characterized in that the movement regions (28, 29) overlap one another only in some regions.

4. The machine tool as defined by claim 1, characterized in that the movement devices (17) each have at least two linear adjusters (19, 25), which define different directions of motion (x, z).

5. The machine tool as defined by claim 4, characterized in that the directions of motion (x, z) of a machining unit (35) are located in a common horizontal plane.

6. The machine tool as defined by claim 4, characterized in that the directions of motion (x, z) of a plurality of machining units (35) are located in a common plane.

7. The machine tool as defined by claim 1, characterized in that the movement devices (17) each have at least one pivoting adjuster (24).

8. The machine tool as defined by claim 1, characterized in that the movement devices (17) each have at least two pivoting adjusters (24, 27), which define two different pivot axes.

9. The machine tool as defined by claim 4, characterized in that the movement devices (17) each have at least two pivoting adjusters (24, 27), which define two different pivot axes, and the first pivot axis matches the first direction of motion (z).

10. The machine tool as defined by claim 9, characterized in that the second pivot axis is oriented transversely to the first pivot axis.

11. The machine tool as defined by claim 1, characterized in that at least one of the linear adjusters includes at least one linear motor (19).

12. The machine tool as defined by claim 1, characterized in that the workpiece supports (7) are provided with automatic clamping devices.

13. The machine tool as defined by claim 1, characterized in that at least one of the machining units (35) is supported adjustably in at least one direction by means of a positioning unit (46).

14. The machine tool as defined by claim 1, characterized in that at least one of the machining units (35) is movable in at least two directions (z, y) by means of a positioning unit (46).

15. The machine tool as defined by claim 1, characterized in that at least one positioning unit (46) includes at least one linear motor.

16. The machine tool as defined by claim 1, characterized in that at least one of the machining units has a turret (39) with a plurality of work spindles (42, 43).

17. The machine tool as defined by claim 1, characterized in that machining units (35) are disposed at different places in the movement region (28, 29).

18. The machine tool as defined by claim 1, characterized in that at least two machining units are disposed at one place in the movement region (28, 29).

19. The machine tool as defined by claim 1, characterized in that the movement region (28, 29) spans at least two machining units.

20. The machine tool as defined by claim 1, characterized in that the workpiece supports are linearly adjustable during the machining of the workpieces.

21. The machine tool as defined by claim 1, characterized in that the workpiece supports are pivotably adjustable during the machining of the workpieces.

22. The machine tool as defined by claim 1, characterized in that the workpiece supports are held in repose for the machining at at least one machining station.
